(19) United States
(12) Patent Application Publication
(10) Pub. No.: US 2022/0198369 A1
(43) Pub. Date: Jun. 23, 2022

(54) MANAGEMENT DEVICE, CONTROL METHOD AND STORAGE MEDIUM

(71) Applicant: NEC Corporation, Minato-ku, Tokyo (JP)

(72) Inventors: Masafumi OYAMADA, Tokyo (JP); Keigo KIMURA, Tokyo (JP); Kunihiro TEKEOKA, Tokyo (JP)

(73) Assignee: NEC Corporation, Minato-ku, Tokyo (JP)

(21) Appl. No.: 17/441,783

(22) PCT Filed: Mar. 28, 2019
(86) PCT No.: PCT/JP2019/013753

§ 371 Date: Sep. 22, 2021

(51) Int. Cl. G06Q 10/06

(52) U.S. Cl. CPC G06Q 10/063114; G06Q 10/06312

(57) ABSTRACT

The acquisition unit 52A acquires task request information S1, which is request information regarding a utilization of data owned by a data owner, from an owner terminal 2 used by the data owner. The determination unit 53A determines, on a basis of the task request information S1, whether or not there is a task that can be performed by use of the data. The notification unit 54A notifies the owner terminal 2 of recommended task information S2 that is information regarding the above-described task when the determination unit 53A determines that there is the above-described task.

### TECHNICAL FIELD

The present invention relates to a technical field of a management device, a control method, and a storage medium for utilizing data.

### BACKGROUND ART

Techniques are known for determining candidates for analytical method to be applied to self-owned data. For example, Patent Literature 1 discloses a data analysis method candidate determining device which determines an analysis method candidate of the analysis target data to be analyzed.

### PRIOR ART DOCUMENTS

### Patent Literature

Patent Literature 1: WO2017/168967

### SUMMARY OF THE INVENTION

### Problem to be Solved by the Invention

In some cases, data owners who collect and manage the data cannot appropriately utilize their owned data in large quantities. Some of such data owners have not been able to utilize data since they do not know how to use the data, despite the existence of effective ways of using the data. No mechanism for supporting such a data owner is disclosed in Patent Literature 1.

In view of the above-described issues, it is therefore an example object of the present disclosure to provide a management device, a control method and a storage medium capable of suitably providing useful information to the data owner.

### Means for Solving the Problem

One mode of the management device is a management device including: an acquisition unit configured to acquire request information regarding a utilization of data owned by a data owner from an owner terminal used by the data owner; a determination unit configured to determine, on a basis of the request information, whether or not there is a task that can be performed by use of the data; and a notification unit configured to notify the owner terminal of information regarding the task when the determination unit determines that there is the task.

One mode of the control method is a control method executed by a management device, the control method including: acquiring request information regarding a utilization of data owned by a data owner from an owner terminal used by the data owner; determining, on a basis of the request information, whether or not there is a task that can be performed by use of the data; and notifying the owner terminal of information regarding the task when it is determined that there is the task.

One mode of the storage medium is a storage medium storing a program executed by a computer, the program causing the computer to function as: an acquisition unit configured to acquire request information regarding a utilization of data owned by a data owner from an owner terminal used by the data owner; a determination unit configured to determine, on a basis of the request information, whether or not there is a task that can be performed by use of the data; and a notification unit configured to notify the owner terminal of information regarding the task when the determination unit determines that there is the task.

### Effect of the Invention

An example advantage according to the present invention is to suitably notify a data owner of information regarding a task that can be performed by use of the data which the data owner designates. This makes it possible to suitably support such data owners who have not been able to utilize their own data without knowing the way of use, despite the existence of effective ways of using the data.

### BRIEF DESCRIPTION OF THE DRAWINGS

FIG. 1 illustrates a configuration of a task management system according to a first example embodiment.

FIG. 2 illustrates a schematic configuration of a management device.

FIG. 3 illustrates a schematic configuration of an owner terminal used by a data owner.

FIG. 4 illustrates a schematic configuration of a terminal device used by a task performer.

FIG. 5 illustrates an example of the data structure of utilization target data information.

FIG. 6 illustrates an example of the data structure of task performer information.

FIG. 7 illustrates an example of a functional block of the management device.

FIG. 8 illustrates a display example of a recommended task view.

FIG. 9 illustrates a display example of an execution model selection view.

FIG. 10 illustrates a display example of an execution model comparison view.

FIG. 11 illustrates an example of a flowchart according to the first example embodiment.

FIG. 12 illustrates a functional block diagram of a management device according to a second example embodiment.

### DESCRIPTION OF EXAMPLE EMBODIMENTS

Hereinafter, with reference to the drawings, example embodiments relating to a management device, a control method and a storage medium will be described.

### First Example Embodiment

(1-1) Configuration of Task Management System

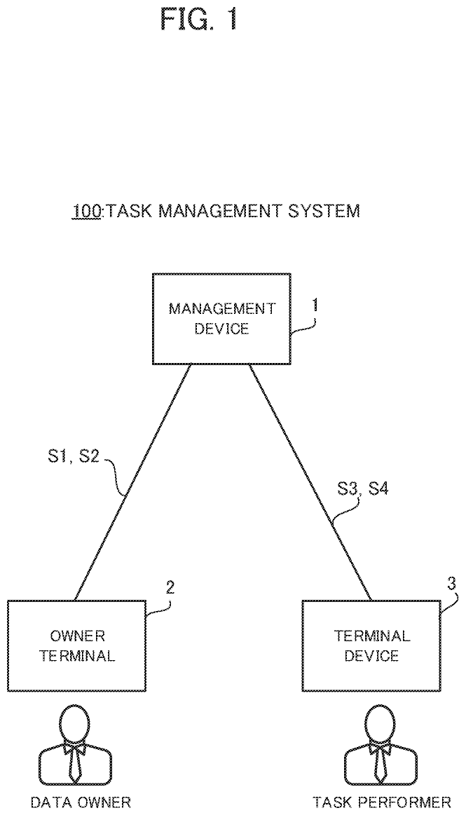

FIG. 1 illustrates the configuration of a task management system 100 according to the first example embodiment. The task management system 100 mainly includes a management device 1 for managing tasks, an owner terminal 2 used by a data owner who owns data, and a terminal device 3 used by a task performer. The term “task” herein indicates process relating to any data analysis such as a demand analysis of commodities, a cancellation analysis of insurance products. Data communication via a communication network or the like is performed between the management device 1 and the owner terminal 2 and between the management device 1 and the terminal device 3, respectively.

Though there are only present one owner terminal 2 and one terminal device 3 in FIG. 1, a plurality of owner terminals 2 and a plurality of terminal devices 3 may be present, respectively. The data owner and the task performer shall include not only individuals but also organizations such as companies.

When the management device 1 receives request information (also referred to as “task request information S1”) regarding the utilization of data owned by the data owner from the owner terminal 2, it determines whether or not there is task(s) that is (can be) performed by use of the data specified by the task request information S1. The management device 1 transmits information (also referred to as “recommended task information S2”) regarding the task(s), which can be performed by use of the target data, to the owner terminal 2. The management device 1 transmits information (also referred to as “task request information S3”) for requesting execution of task by use of specific data to the terminal device 3 which the task performer uses. The management device 1 receives, as a response to the task request information S3, information (also referred to as “task performance information S4”) indicating the result of performing the task by the terminal device 3 from the terminal device 3.

The owner terminal 2 generates the task request information S1 relating to the target data (also referred to as “utilization target data”) of utilization designated by the data owner, and transmits the task request information S1 to the management device 1. The task request information S1 may include the utilization target data itself, or may include information (i.e., metadata) for identifying the utilization target data in place of the utilization target data itself Further, the utilization target data is not limited to one type of data, and it may include multiple types of data.

When the owner terminal 2 receives the recommended task information S2 from the management device 1 as a response to the task request information S1, it displays information based on the recommended task information S2. A display example based on the recommended task information S2 will be described later.

When receiving the task request information S3 from the management device 1, the terminal device 3 performs the task, which is specified by the task request information S3, by using the data specified by the task request information S3. The terminal device 3 transmits the task performance information S4 indicating the result of performing the task to the management device 1.

The configuration of the task management system 100 is not limited to the configuration shown in FIG. 1. For example, instead of transmitting the task performance information S4 to the management device 1, the terminal device 3 may transmit the task performance information S4 to the owner terminal 2. Further, instead of the terminal device 3 performing the task based on the task request information S3, the management device 1 or the owner terminal 2 may perform the task by receiving a program or the like necessary for performing the task from the terminal device 3.

(1-2) Device Configuration

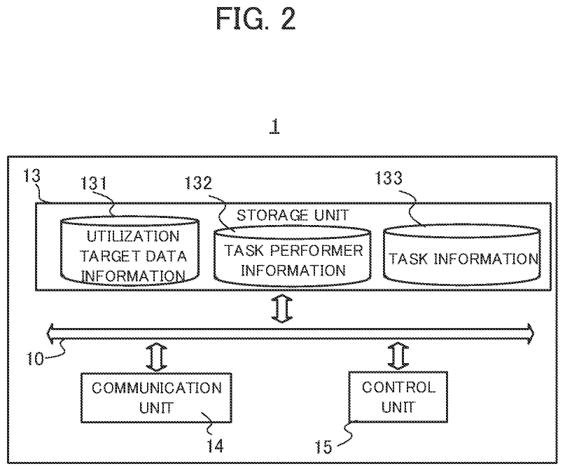

Next, each configuration of the management device 1, the owner terminal 2, and the terminal device 3 will be described with reference to FIGS. 2 to 4.

FIG. 2 illustrates a schematic configuration of the management device 1. The management device 1 mainly includes a storage unit 13, a communication unit 14 for performing data communication and a control unit 15.

The storage unit 13 is configured by memories such as a hard disk and a flash memory. The storage unit 13 stores a program to be executed by the control unit 15, and other information necessary for the control unit 15 to execute a predetermined process by executing the program. The above-described program may be stored in any storage medium other than the storage unit 13.

The storage unit 13 stores utilization target data information 131, task performer information 132 and task information 133.

The utilization target data information 131 is information regarding the utilization target data and is generated based on the task request information S1 received from the owner terminal 2. Specific examples of the data structure of the utilization target data information 131 will be described later.

The task performer information 132 is information relating to the task performer corresponding to the terminal device 3 and includes identification information representing the task performer and information on task(s) that are performed by the task performer. The task performer information 132 is generated, for example, based on the registration information regarding the task performer transmitted from the terminal device 3 to the management device 1. Specific examples of the data structure of the task performer information 132 will be described later.

The task information 133 is information relating to tasks that the management device 1 can propose to the owner terminal 2. The task information 133 is generated with respect to each of the tasks, and includes, for example, information on the data necessary for performing each of the tasks, the price of each of the tasks, the accuracy of each of the tasks and the effect by performing each of the tasks. For example, the information may be generated by aggregating, with respect to each of the tasks, information such as necessary data information, price information, accuracy information and effect information which are included in model information of the task performer information 132 to be mentioned later.

The control unit 15 includes a CPU (Central Processing Unit), a ROM (Read Only Memory) and a RAM (Random Access Memory) which are not shown and performs various controls for the components in the management device 1. The control unit 15 functions as a computer for executing a program. The process which the control unit 15 executes will be described later.

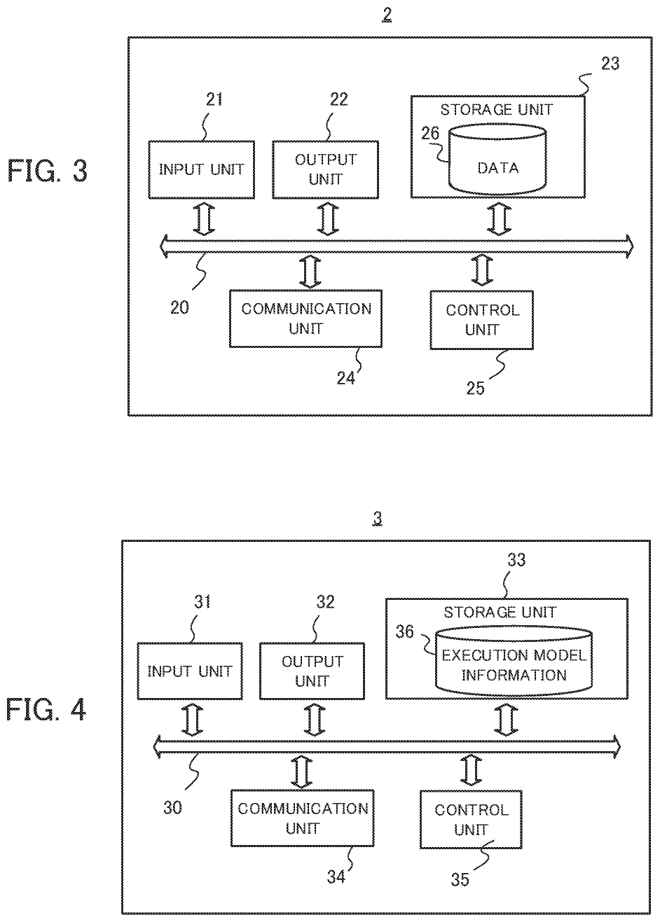

FIG. 3 illustrates a schematic configuration of the owner terminal 2. The owner terminal 2 mainly includes an input unit 21, an output unit 22, a storage unit 23, a communication unit 24 for performing data communication and a control unit 25. Each of these elements is connected to one another via a bus line 20.

The input unit 21 is an interface that accepts an input of a user, and corresponds to, for example, a touch panel, a button, a voice input device or the like. The output unit 22 is an interface for outputting information to the user such as a display for displaying information and a speaker for outputting sound.

The storage unit 23 is configured by memories such as a hard disk and a flash memory. The storage unit 23 stores a program to be executed by the control unit 25, and other information necessary for the control unit 25 to execute a predetermined process by executing a program. Further, the storage unit 23 stores the data 26 including the utilization target data.

The control unit 25 includes a CPU, a ROM and a RAM which are not shown and performs various controls for each component in the owner terminal 2. For example, the control unit 25 generates the task request information S1 that specifies the data designated by the input unit 21 as the utilization target data, and transmits the task request information S1 to the management device 1 through the communication unit 24. Further, when the communication unit 24 receives the recommended task information S2 from the management device 1, the control unit 25 displays information based on the recommended task information S2 by controlling the output unit 22.

FIG. 4 illustrates a schematic configuration of the terminal device 3. The terminal device 3 mainly includes an input unit 31, an output unit 32, a storage unit 33, a communication unit 34 for performing data communication and a control unit 35. Each of these elements is connected to one another via a bus line 30.

The input unit 31 is an interface that accepts an input of a user, and corresponds to, for example, a touch panel, a button, a voice input device and/or the like. The output unit 32 is an interface for outputting information to the user such as a display for displaying information and a speaker for outputting sound.

The storage unit 33 is configured by memories such as a hard disk and a flash memory. The storage unit 33 stores a program to be executed by the control unit 35 and other information necessary for the control unit 35 to execute a predetermined process by executing a program.

Further, the storage unit 33 stores the execution model information 36. The execution model information 36 is information on an execution model which is necessary for the task performer that is the user of the terminal device 3 to perform the task. For example, execution model information 36 may include a program of the execution model such as an analysis engine and analysis scripts.

The control unit 35 includes a CPU, a ROM and a RAM which are not shown and performs various controls for each component in the terminal device 3. For example, in a case where the communication unit 34 receives the task request information S3 from the management device 1, on the basis of the execution model information 36, the control unit 35 applies the execution model specified by the task request information S3 to the utilization target data indicated by the task request information S3. Then, the control unit 35 transmits information indicating the execution result to the management device 1 through the communication unit 34 as the task performance information S4.

(1-3) Data Structure

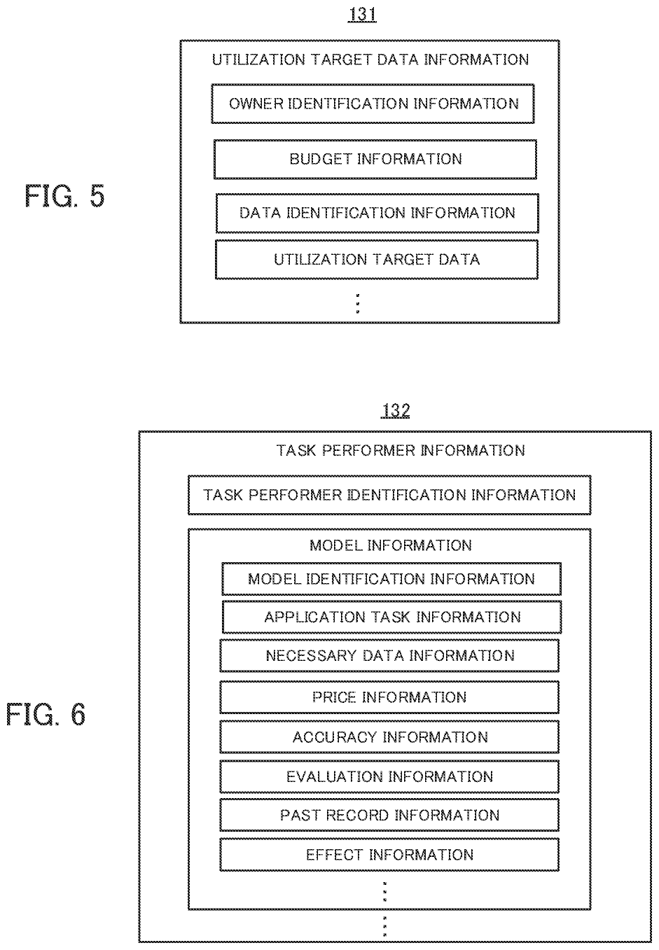

A specific example of the data structure of the utilization target data information 131 and the task performer information 132 will be described with reference to FIGS. 5 and 6.

FIG. 5 is an example of a data structure of the utilization target data information 131. The utilization target data information 131 is, for example, generated for each task request information S1 received from the owner terminal 2, and includes owner identification information, budget information, data identification information, and utilization target data.

The “OWNER IDENTIFICATION INFORMATION” is information that identifies the owner of the utilization target data (that is, the data owner using the owner terminal 2). The owner identification information may include information regarding the attributes of the data owner, such as the company name, the industry type and the like. The “BUDGET INFORMATION” is information that indicates the budget which the data owner can spend on data utilization. The “DATA IDENTIFICATION INFORMATION” is information (metadata) for identifying the utilization target data, and includes information indicating various attributes of the utilization target data such as the name of the utilization target data and the data size thereof. When the target utilization target data includes multiple types of data, the “DATA IDENTIFICATION INFORMATION ” includes information for identifying each type of data. The “UTILIZATION TARGET DATA” is raw data of the utilization target data.

The data structure of the utilization target data information 131 is not limited to the example shown in FIG. 5. For example, the utilization target data information 131 may not include the “UTILIZATION TARGET DATA”. In this case, for example, the owner terminal 2 may directly transmit the utilization target data to the terminal device 3 corresponding to the task performer who performs the task when the task to be applied to the utilization target data is determined.

FIG. 6 is an example of a data structure of the task performer information 132. The task performer information 132 is, for example, generated with respect to each task performer using each terminal device 3. The task performer information 132 includes task performer identification information, that is the identification information representing the task performer, and model information.

The model information is information on the execution model for performing the task. Here, the execution model is an algorithm for performing the task or a program for implementing the algorithm. For example, if the task is a demand analysis for a particular commodity, the execution model may be an analysis algorithm for performing the demand analysis, or an analysis engine or analysis scripts for implementing the analysis algorithm.

The model information is prepared for each of execution models possessed by the target task performer, and mainly includes model identification information, application task information, necessary data information, price information, accuracy information, evaluation information, past record information and effect information.

The “MODEL IDENTIFICATION INFORMATION” is the identification information representing each of the execution models. The “APPLICATION TASK INFORMATION” indicates the identification information representing the task to which each of the execution models is applied. “NECESSARY DATA INFORMATION” indicates the identification information representing the data necessary for executing the target execution model. If there are multiple combination patterns of data required for executing the target execution model, the necessary data information may indicate a combination of data for each pattern. The “PRICE INFORMATION” indicates the asking price set by the task performer for the execution of the target execution model.

The “ACCURACY INFORMATION” indicates the accuracy calculated on the assumption that each of the execution models is executed. If there are multiple combination patterns of data according to the necessary data information, the accuracy information may be table information indicating the accuracy with respect to each pattern. The “EVALUATION INFORMATION” indicates an evaluation (e.g., an index value representing the evaluation) from the data owner at the time when each of the execution models was performed based on the task request information S3 in the past. The “PAST RECORD INFORMATION” indicates information (e.g., the number of execution times) relating to past records of performing each of the execution models based on the task request information S3 in the past.

The “EFFECT INFORMATION” indicates the effect made on the assumption that each of the execution models is executed. For example, the effect may be a contribution to KPI (Key Performance Indicator). In this case, for example, the effect information may be a table information or the like showing the contribution when each of the execution models is performed for each KPI to be assumed.

The data structure of the task performer information 132 is not limited to the data structure shown in FIG. 6. For example, the evaluation information and the past record information may exist independently of the model information instead of being included in the model information. In this case, the evaluation information may be information indicating an evaluation regarding the task performer. Similarly, the past record information may be information indicative of the past records regarding the task performer.

(1-4) Functional Block

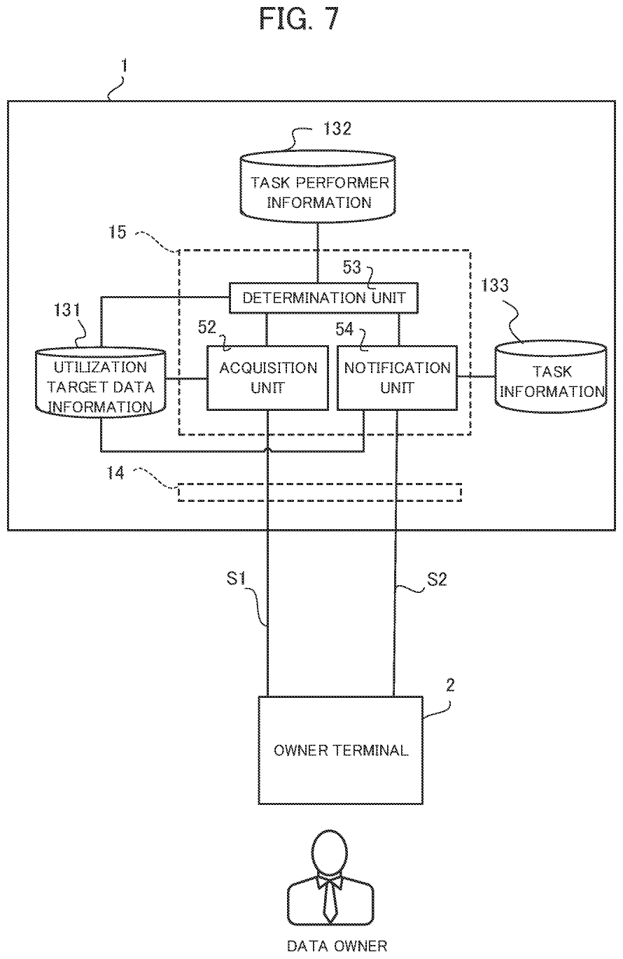

FIG. 7 illustrates an example of a function block of the management device 1 relating to reception of the task request information S1 and transmission of the recommended task information S2. The control unit 15 of the management device 1 functionally includes an acquisition unit 52, a determination unit 53 and a notification unit 54.

The acquisition unit 52 receives the task request information S1 from the owner terminal 2 through the communication unit 14. The acquisition unit 52 generates the utilization target data information 131 based on the received task request information S1 and stores the generated utilization target data information 131 in the storage unit 13.

The determination unit 53 refers to the utilization target data information 131 generated by the acquisition unit 52 and the task performer information 132 and thereby determines whether or not there is a task that is (can be) performed by use of the utilization target data. The determination unit 53 determines that the task which can be performed by use of the utilization target data is a task (also called “recommended task”) to be recommended to the data owner.

For example, the determination unit 53 determines the presence/absence of the task that can be performed by use of the utilization target data based on: the data identification information (see FIG. 5) of the utilization target data information 131; the necessary data information included in the model information of the task performer information 132; and the application task information (see FIG. 6). When there is the task that can be performed by use of the target data, the determination unit 53 recognizes the task as a recommended task. For example, when the data indicated by the data identification information of the utilization target data information 131 is included in the data indicated by the necessary data information of the task performer information 132, the determination unit 53 recognizes the task indicated by the application task information corresponding to the necessary data information as the recommended task. The determination unit 53 supplies information for identifying the recommended task to the notification unit 54.

Here, the term “task that can be performed by use of the target data” may indicate a task (also referred to as “first task”) that is performed without requiring data other than the utilization target data (i.e., with only the target utilization target data). In another example, the term “task that can be performed by use of the target data” may indicate not only the first task but also a task (also referred to as the “second task”) that requires other data other than the utilization target data. In the latter example, the term “task that can be performed by use of the target data” refers to a task that require at least the utilization target data. In this case, for example, the determination unit 53 may use all the first task as recommended task and further use, as the recommended task, the second task which requires only a predetermined number or less of the other data in addition to the utilization target data.

Further, the determination unit 53 may further compare the budget information of the utilization target data information 131 with the price information corresponding to tasks included in the task information 133 thereby to determine whether or not each of the tasks is a recommended task. In this case, for example, the determination unit 53 determines the recommended task to be such a task which is (can be) performed by use of the utilization target data and whose price indicated by the price information is within the limits of the budget indicated by the above-described budget information.

The notification unit 54 extracts from the task information 133 information regarding the task recognized as the recommended task by the determination unit 53, and transmits the recommended task information S2, which includes the information on the recommended task, to the owner terminal 2. Specifically, the notification unit 54 transmits the display information for displaying a recommended task view to be described later to the owner terminal 2 as the recommended task information S2. The recommended task view includes information relating to the utilization target data in addition to the information relating to the recommended task, as described below.

When the notification unit 54 detects that one of recommended tasks is selected on the recommended task view, it transmits to the owner terminal 2 the display information regarding an execution model selection view for selecting the execution model necessary for performing the selected recommended task. Thereby, the notification unit 54 preferably causes the data owner of the owner terminal 2 to select the execution model necessary for executing the selected recommended task. After that, when the notification unit 54 detects the selection of the execution model on the execution model selection view, it transmits the task request information S3 to the terminal device 3 corresponding to the model executer that executes the selected execution model.

(1-5) Display Example

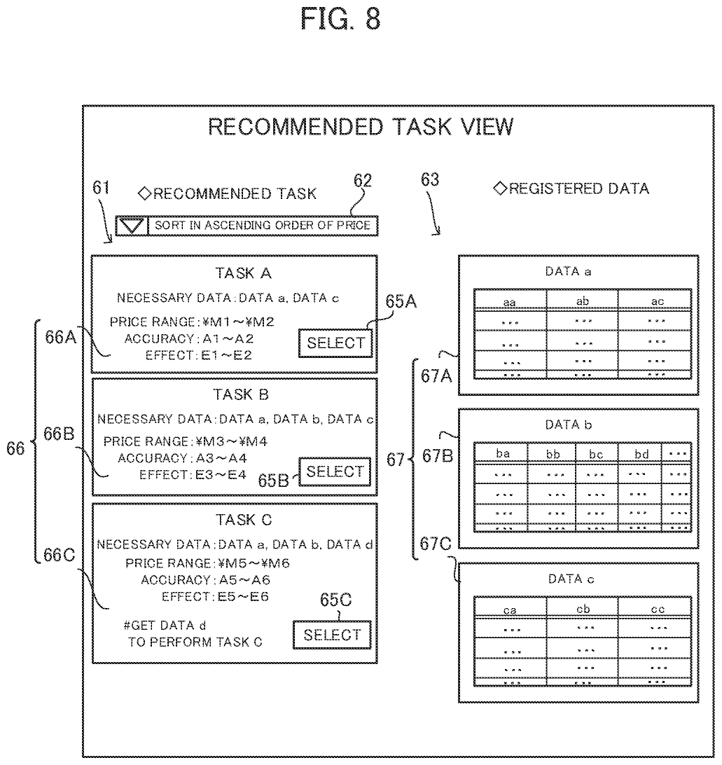

FIG. 8 illustrates a display example of a recommended task view displayed by the owner terminal 2 on the basis of the recommended task information S2. As illustrated in FIG. 8, the notification unit 54 of the management device 1 controls the owner terminal 2 to display a recommended task list 61, a sort selection field 62, and a registered data list 63 on the owner terminal 2 on the recommended task view.

The recommended task list 61 includes recommended task display fields 66 (66A to 66C) which shows information for each recommended task. Here, the recommended task display field 66A and the recommended task display field 66B are display fields which show information relating to the first tasks, and the recommended task display field 66C are display fields which shows information relating to the second task.

Each recommended task display field 66 has respective display areas corresponding to “NECESSARY DATA”, “PRICE RANGE”, “ACCURACY” and “EFFECT” and selection buttons 65A to 65C for selecting each recommended task. For example, by referring to the task information 133, the notification unit 54 acquires information to be displayed in the respective display areas corresponding to the “NECESSARY DATA”, “PRICE RANGE”, “ACCURACY” and “EFFECT”.

The notification unit 54 shows data necessary for performing the corresponding recommended task as “NECESSARY DATA” to be displayed in each recommended task display field 66. Further, the notification unit 54 displays the range of the price necessary for performing the corresponding recommended task as “PRICE RANGE” to be displayed in each recommended task display field 66. It is noted that the price range indicates, for example, the range of the price required for the use of an execution model applicable to the corresponding recommended tasks.

The notification unit 54 shows the accuracy of the task when the corresponding recommended task is performed as the “ACCURACY” to be displayed in each recommended task display field 66. It is noted that since the accuracy of the task to be performed depends on the execution model to be used, the notification unit 54 displays, as the “ACCURACY”, the range of accuracy calculated on the assumption that each of multiple execution models applicable to the corresponding recommended task is executed, for example. The notification unit 54 shows the effect (effectiveness) when the corresponding recommended task is performed as the “effect” to be displayed in the recommended task display field 66. Since the effect differs depending on the execution model to be used, the notification unit 54 indicates, as the “EFFECT”, the range of the effect when each of the multiple execution models applicable to the corresponding recommended task is executed, for example.

The notification unit 54 displays, in the recommended task display field 66C that displays the second task as a recommended task, information relating to data (here, “DATA d”) that is not possessed but needed by the data owner who is the viewer when the data owner performs the target second task (here, “TASK C”). Thereby, the notification unit 54 can suitably let the data owner recognize the data to be newly purchased or to be generated in order to perform the recommended task of interest.

The notification unit 54 displays a sort selection field 62 for determining the order of the recommended task display fields 66 in the recommended task list 61. Here, as an example, the sort selection field 62 is a selection field in a pull-down menu format, and in FIG. 8, the item “SORT IN ASCENDING ORDER OF PRICE” is selected. Then, in this case, for example, the notification unit 54 arranges and displays the recommended task display fields 66A to 66C in ascending order of the corresponding price range (e.g., lowest price or intermediate (median) price thereof). The sort selection field 62 may have any selection items such as “SORT IN DESCENDING ORDER OF ACCURACY” and “SORT IN DESCENDING ORDER OF EFFECT” in addition to “SORT IN ASCENDING ORDER OF PRICE”. For example, when the item “SORT IN DESCENDING ORDER OF ACCURACY” is selected, the notification unit 54 arranges and displays the recommended task display fields 66A to 66C in descending order of the lowest value or the highest value or the intermediate value of the corresponding accuracy.

The registered data list 63 is a list of the utilization target data notified by the owner terminal 2 to the management device 1 through the task request information S1. The registered data list 63 includes registered data display fields 67 (67A to 67C) showing information regarding respective utilization target data. Here, there are at least “DATA a”, “DATA b” and “DATA c” as the utilization target data, and the notification unit 54 displays data structures thereof on the registered data display fields 67A to 67C, respectively. Thereby, the data owner can appropriately grasp the contents of the utilization target data which the data owner possesses.

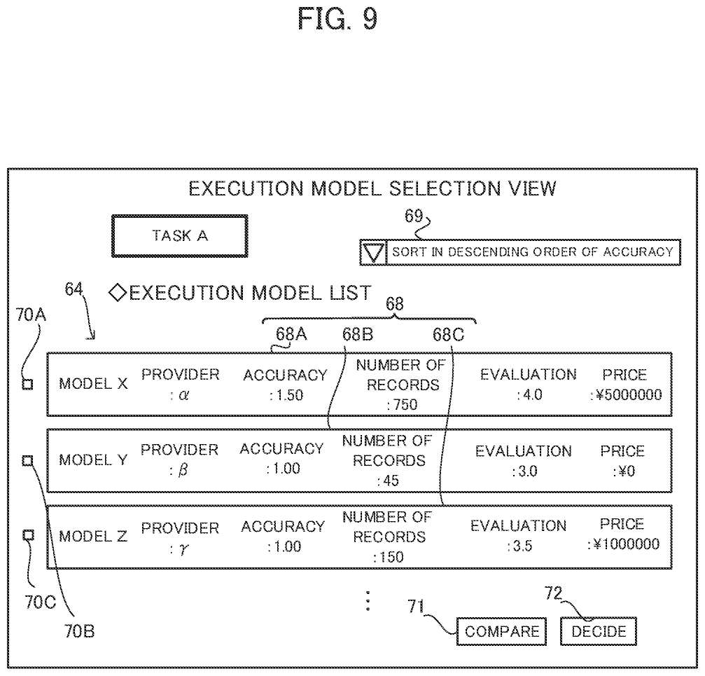

FIG. 9 is a display example of an execution model selection view that is displayed when any of the recommended tasks is selected on the recommended task view.

In this case, since the notification unit 54 detects the selection of the determination button 65A corresponding to the “TASK A” on the recommended task view illustrated in FIG. 8, the notification unit 54 controls the owner terminal 2 to display the execution model selection view relating to the execution model of the recommended task “Task A”. As shown in FIG. 9, the notification unit 54 controls the owner terminal 2 to display an execution model list 64, a sort selection field 69, a comparison button 71, and a decision button 72 on the execution model selection view.

The execution model list 64 includes execution model display fields 68 (68A, 68B, 68C, . . . ) showing information regarding respective execution models that the management device 1 can provide for the target recommended task. In the example of FIG. 9, the execution model display fields 68A to 68C corresponding to the execution models “MODEL X”, “MODEL Y” and “model Z” are displayed, respectively. Further, in the execution model display fields 68A to 68C, check boxes 70A to 70C for selection are displayed, respectively.

On the basis of the task performer information 132 (see FIG. 6), the notification unit displays “PROVIDER”, “ACCURACY”, “NUMBER OF RECORDS”, “EVALUATION” and “PRICE” on each execution model display field 68, respectively. Here, the notification unit 54 displays, as the “PROVIDER”, a task provider (task performer) that provides (executes) the target execution model. For example, when the task performer is a company, the notification unit 54 displays the name or the like of the above-described company as the “PROVIDER”.

Further, the notification unit 54 displays the accuracy of the target execution model as the “ACCURACY” based on the accuracy information included in the target model information. Further, the notification unit 54 displays the number of past records of execution of the execution model (the number of times of executing the execution model) as the “NUMBER OF RECORDS”, based on the past record information included in the corresponding model information. Further, the notification unit 54 displays, as the “EVALUATION”, the past evaluation (here, an index value of 0.0 to 5.0) of the corresponding execution model based on the evaluation information included in the corresponding model information. Further, the notification unit 54 displays, as the “PRICE”, the price required for executing the corresponding execution model based on the price information included in the corresponding model information. It is noted that the notification unit 54 may display on each execution model display field 68 any item other than the items described above (e.g., the effect of the execution model).

Further, the notification unit 54 displays the sort selection field 69 for determining the order of the execution model display fields 68 in the execution model list 64. Here, as an example, the sort selection field 69 is a selection field in a pull-down menu format, and the item “SORT IN DESCENDING ORDER OF ACCURACY” is selected in FIG. 9. Then, in this case, the notification unit 54 arranges and displays the execution model display fields 68A to 68C in descending order of the degree of the accuracy. It is noted that the sort selection field 62 may have any selection items such as “SORT IN DESCENDING ORDER OF NUMBER OF RECORDS”, “SORT IN DESCENDING ORDER OF EVALUATION”, “SORT IN ASCENDING ORDER OF PRICE” and “SORT IN DESCENDING ORDER OF EFFECT” in addition to the item “SORT IN DESCENDING ORDER OF ACCURACY”.

Further, if the notification unit 54 detects the selection of the comparison button 71 in such a state that any two of the check boxes 70A to 70C are selected, the notification unit 54 displays an execution model comparison view for comparing the two execution models corresponding to the selected two check boxes. The execution model comparison view will be described later. When the notification unit 54 detects that the determination button 72 is selected while one of the check box 70A to 70C is selected, the notification unit 54 determines that the execution model corresponding to the selected check box is selected by the data owner. Therefore, in this case, the notification unit 54 transmits the task request information S3 to the terminal device 3 corresponding to the task performer which provides the execution model corresponding to the selected check box.

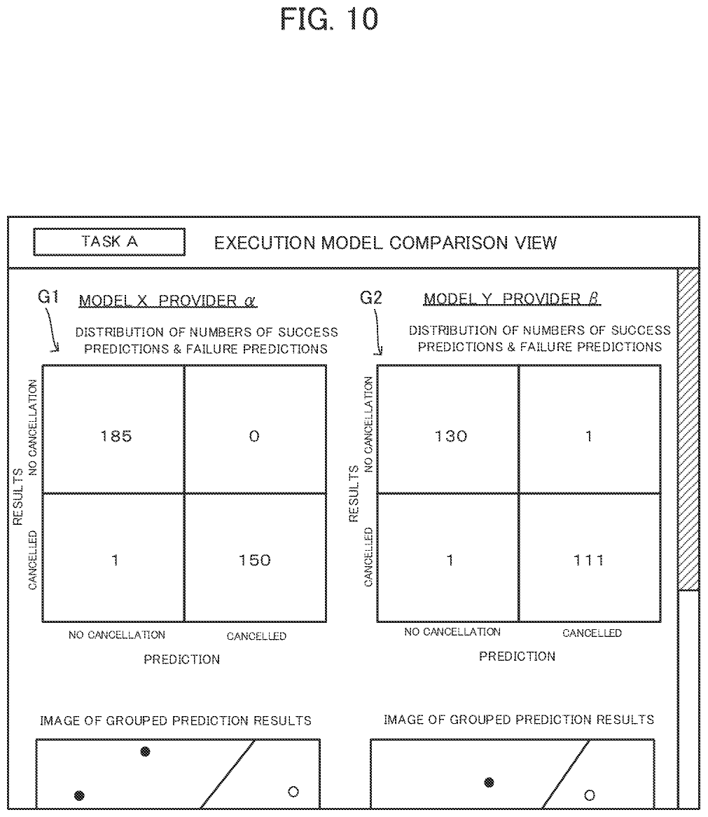

FIG. 10 is a display example of the execution model comparison view. In this case, on the execution model selection view illustrated in FIG. 9, the notification unit 54 firstly detects that the comparison button 71 is selected while the check box 70A corresponding to the MODEL X and the check box 70B corresponding to the MODEL Y are selected. Then, the notification unit 54, in this case, transmits to the owner terminal 2 the display information regarding the execution model comparison view for comparing execution models of the MODEL X and the MODEL Y. Thereby, the notification unit 54 displays the execution model comparison view shown in FIG. 10 on the owner terminal 2. Here, as an example, the MODEL X and the MODEL Y are models each predicting the cancellation of a commodity such as an insurance.

On the execution model comparison view shown in FIG. 10, the notification unit 54 arranges and displays graphs indicating indexes regarding the performance and the like for each of the MODEL X and the MODEL Y In the example of FIG. 10, the notification unit 54 displays the graph G1 and the graph G2 side by side, wherein the graph G1 indicates the distribution of the number of success predictions regarding cancellation and the number of failure predictions regarding cancellation according to the MODEL X and the graph G2 indicates the distribution of the number of success predictions regarding cancellation and the number of failure predictions regarding cancellation according to the MODEL Y. The notification unit 54 displays on the execution model comparison view other graphs for comparing the performance of the MODEL X and the MODEL Y by various indexes in addition to the graphs G1 and G2.

(1-6) Processing Flow

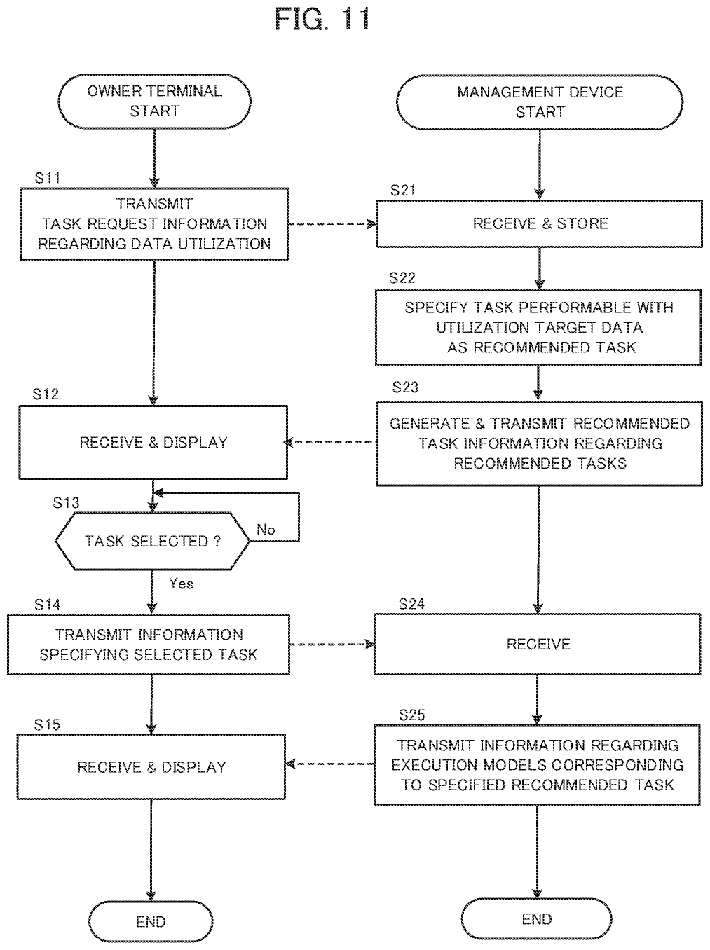

FIG. 11 is an example of a flowchart illustrating a processing procedure of the management device 1 and the owner terminal 2 relating to the display of the recommended task view and the execution model selection view.

First, when the input unit 21 detects an input indicating the utilization of the utilization target data, the owner terminal 2 generates task request information S1 relating to the utilization of the designated utilization target data, and transmits the task request information S1 to the management device 1 (Step S11).

The management device 1 receives the task request information S1 from the owner terminal 2 and stores the utilization target data information 131 generated based on the task request information S1 (step S21). Then, the management device 1 refers to the task performer information 132 and specifies a task that can be performed by use of the utilization target data specified by the task request information S1 as a recommended task (step S22). In this case, the management device 1 may determine that the recommended task is the first task to be performed only by use of the utilization target data, or may determine that the recommended tasks are the first task and the second task that requires other data other than the utilization target data.

The management device 1 generates the recommended task information S2 relating to recommended tasks specified at step S22 and transmits the generated recommended task information S2 to the management device 1 (step S23). In this case, the management device 1 generates the display information for displaying the recommended task view as the recommended task information S2.

After the transmission of the task request information S1 at step S11, the owner terminal 2 receives the recommended task information S2 from the management device 1 as a response to the task request information S1 and displays the recommended task view by controlling the output unit 22 based on the received recommended task information S2 (step S12). The owner terminal 2 determines whether or not any task is selected from the list of recommended tasks displayed on the recommended task view (step S13). When detecting the selection of an arbitrary task from the list of recommended tasks (step S13: Yes), the owner terminal 2 transmits information specifying the selected task to the management device 1 (step S14).

The management device 1 receives the information that the owner terminal 2 transmitted at step S14 (step S24). In this case, the management device 1 refers to the task performer information 132 and specifies execution models corresponding to the task specified by the information received at step S24. The management device 1 transmits information on the execution models corresponding to the specified task to the owner terminal 2 (step S25). Specifically, the management device 1 transmits, for example, display information for displaying an execution model selection view as shown in FIG. 9 as the information described above.

As a response to the information transmitted at step S14, the owner terminal 2 receives the information regarding the execution models corresponding to the task selected at step S13, and displays information based on the received information (step S15). In this case, the owner terminal 2 displays the execution model selection view shown in FIG. 9 based on the received information.

As described above, according to the first example embodiment, when receiving the task request information S1 which specifies the utilization target data from the owner terminal 2, the management device 1 presents to the data owner a recommended task view showing a list of recommended tasks that can utilize the utilization target data. This enables the data owner to suitably grasp the way of use of the owned data. Therefore, the data owner can suitably solve such a problem that the data cannot be utilized without knowing the way of use of the data, despite the existence of an effective way of use of the data. In addition, the management device 1 includes information such as the price, the accuracy, and the effect (effectiveness) thereof in the information regarding the recommended tasks to be displayed on the owner terminal 2, which enables the data owner to suitably grasp cost required for the proposed recommended tasks and the effect and accuracy thereof calculated on the assumption that each of the recommended tasks is performed.

### Second Example Embodiment

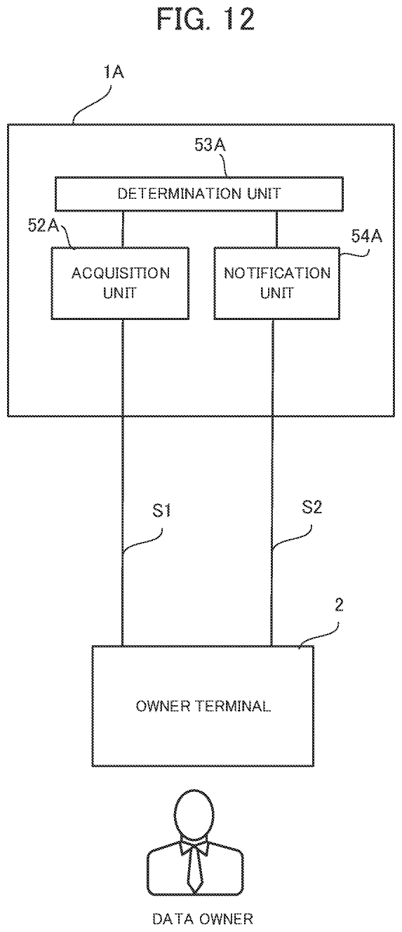

FIG. 12 is a functional block diagram of a management device 1A according to the second example embodiment. The management device 1A functionally includes an acquisition unit 52A, a determination unit 53A and a notification unit 54A.

The acquisition unit 52A acquires task request information S1, which is request information regarding a utilization of data owned by a data owner, from an owner terminal 2 used by the data owner. The determination unit 53A determines, on a basis of the task request information S1, whether or not there is a task that can be performed by use of the data. The notification unit 54A notifies the owner terminal 2 of recommended task information S2 that is information regarding the above-described task when the determination unit 53A determines that there is the above-described task.

Even according to the second example embodiment, the management device 1A can also suitably notify the owner terminal 2 of information regarding a task that can utilize the data owned by the owner terminal 2.

The whole or a part of the example embodiments described above (including modifications, the same applies hereinafter) can be described as, but not limited to, the following Supplementary Notes.

[Supplementary Note 1]

A management device comprising:

an acquisition unit configured to acquire request information regarding a utilization of data owned by a data owner from an owner terminal used by the data owner;

a determination unit configured to determine, on a basis of the request information, whether or not there is a task that can be performed by use of the data; and

a notification unit configured to notify the owner terminal of information regarding the task when the determination unit determines that there is the task.

[Supplementary Note 2]

The management device according to Supplementary Note 1,

wherein the information regarding the task includes information regarding an accuracy or an effect on an assumption that the data owner performs the task by use of the data.

[Supplementary Note 3]

The management device according to Supplementary Note 1 or 2

wherein the information regarding the task includes information regarding a price of performing the task.

[Supplementary Note 4]

The management device according to any one of Supplementary Notes 1 to 3,

wherein the request information includes information regarding a budget for the utilization of the data, and

wherein the determination unit determines whether or not there is the task that can be performed by use of the data and within limits of the budget.

[Supplementary Note 5]

The management device according to any one of Supplementary Notes 1 to 4,

wherein, when receiving, from the owner terminal, information which specifies one of the tasks, the notification unit notifies the owner terminal of information regarding an execution model for performing the specified task.

[Supplementary Note 6]

The management device according to Supplementary Note 5,

wherein the information regarding the execution model indicates at least one of a provider of the execution model, an accuracy of the execution model, a past record regarding the execution model or an evaluation of the execution model.

[Supplementary Note 7]

The management device according to any one of Supplementary Notes 1 to 6,

wherein the determination unit determines whether or not there is a first task that is performed without use of other data other than the data as the task that can be performed by use of the data, and

wherein the notification unit notifies the owner terminal of the information regarding the first task.

[Supplementary Note 8]

The management device according to Supplementary Note 7,

wherein the determination unit determines whether or not there are the first task and a second task as the task that can be performed by use of the data, the second task requiring the other data in addition to the data, and

wherein the notification unit notifies the owner terminal of the information regarding the first task and the second task.

[Supplementary Note 9]

The management device according to Supplementary Note 7,

wherein the information regarding the second task includes information regarding the other data.

[Supplementary Note 10]

A control method executed by a management device, the control method comprising:

acquiring request information regarding a utilization of data owned by a data owner from an owner terminal used by the data owner;

determining, on a basis of the request information, whether or not there is a task that can be performed by use of the data; and

notifying the owner terminal of information regarding the task when it is determined that there is the task.

[Supplementary Note 11]

A storage medium storing a program executed by a computer, the program causing the computer to function as:

an acquisition unit configured to acquire request information regarding a utilization of data owned by a data owner from an owner terminal used by the data owner;

a determination unit configured to determine, on a basis of the request information, whether or not there is a task that can be performed by use of the data; and

a notification unit configured to notify the owner terminal of information regarding the task when the determination unit determines that there is the task.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent Literatures mentioned in this specification are incorporated by reference in its entirety.

### DESCRIPTION OF REFERENCE NUMERALS

1, 1A Management device

2 Owner terminal

3 Terminal device

21,31 Input unit

22,32 Output unit

13, 23, 33 Storage unit

14, 24, 34 Communication unit

15, 25, 35 Control unit

100 Task management system

What is claimed is:

1. A management device comprising a processor configured to:
acquire request information regarding a utilization of data owned by a data owner from an owner terminal used by the data owner;
determine, on a basis of the request information, whether or not there is a task that can be performed by use of the data; and
notify the owner terminal of information regarding the task when it is determined that there is the task.

2. The management device according to claim 1,
wherein the information regarding the task includes information regarding an accuracy or an effect on an assumption that the data owner performs the task by use of the data.

3. The management device according to claim 1
wherein the information regarding the task includes information regarding a price of performing the task.

4. The management device according claim 1,
wherein the request information includes information regarding a budget for the utilization of the data, and
wherein the processor determines whether or not there is the task that can be performed by use of the data and within limits of the budget.

5. The management device according to claim 1,
wherein, when receiving, from the owner terminal, information which specifies one of the tasks, the processor notifies the owner terminal of information regarding an execution model for performing the specified task.

6. The management device according to claim 5,
wherein the information regarding the execution model indicates at least one of a provider of the execution model, an accuracy of the execution model, a past record regarding the execution model or an evaluation of the execution model.

7. The management device according to claim 1,
wherein the processor determines whether or not there is a first task that can be performed without use of other data other than the data as the task that can be performed by use of the data, and
wherein the notification unit processor notifies the owner terminal of the information regarding the first task.

8. The management device according to claim 7,
wherein processor determines whether or not there are the first task and a second task as the task that can be performed by use of the data, the second task requiring the other data in addition to the data, and
wherein the processor notifies the owner terminal of the information regarding the first task and the second task.

9. The management device according to claim 7,
wherein the information regarding the second task includes information regarding the other data.

10. A control method executed by a management device, the control method comprising:
acquiring request information regarding a utilization of data owned by a data owner from an owner terminal used by the data owner;
determining, on a basis of the request information, whether or not there is a task that can be performed by use of the data; and
notifying the owner terminal of information regarding the task when it is determined that there is the task.

11. A non-transitory computer-readable storage medium storing a program executed by a computer, the program causing the computer to:
acquire request information regarding a utilization of data owned by a data owner from an owner terminal used by the data owner;
determine, on a basis of the request information, whether or not there is a task that can be performed by use of the data; and
notify the owner terminal of information regarding the task when it is determined that there is the task.
